(19) United States
(12) Patent Application Publication
(10) Pub. No.: US 2005/0024411 A1
(43) Pub. Date: Feb. 3, 2005

(54) Printer system

(75) Inventors: Toshihiko Takenouchi, Ibaraki (JP); Seiji Kageyama, Ibaraki (JP); Susumu Hashimoto, Ibaraki (JP); Shinichi Kishi, Ibaraki (JP); Muneyoshi Akai, Ibaraki (JP); Hiroshi Udo, Ibaraki (JP)

Correspondence Address: MCGINN & GIBB, PLLC, 8321 OLD COURTHOUSE ROAD, SUITE 200, VIENNA, VA, 22182-3817, US

(73) Assignee: Hitachi Printing Solutions, Ltd., Tokyo (JP)

(21) Appl. No.: 10/854,412

(22) Filed: May 27, 2004

(30) Foreign Application Priority Data
May 30, 2003 (JP) P.2003-154173
Jun. 5, 2003 (JP) P.2003-160190

(51) Int. Cl. B41J 29/38

(52) U.S. Cl. 347/16

(57) ABSTRACT

A printer system includes a plurality of printing mechanisms, a paper inversion mechanism that inverts a paper between the printing mechanisms, a paper buffer that adjusts a time lag in a synchronous operation, and a controller that receives print data from a host computer and synchronously operates the printing mechanisms to perform double-strike or double-sided printing. Preferably, the controller includes a unit that measures a length of a paper path extended between the printing mechanisms and enters a setup value to perform error recovery printing, an image buffer that stores an amount of data equivalent to a distance between an image transfer point and a fixing point, a pointer function that indicates locations of image data and of data in the image buffer, and a function that employs the pointer function to calculate a range and performs error recovery printing, when a malfunction has occurred and a paper is re-loaded.

### BACKGROUND OF THE INVENTION

1. Field of the Invention

The present invention relates to a printer system wherein a plurality of printing mechanisms are interconnected to enable double-sided printing, spot-color printing and magnetic-toner printing.

2. Background Art

A printer system for synchronized operations is presently available wherein two independent, fast, single-sided printing mechanisms are so connected that upon the reception, via a network, of print job data from a host computer, the first printing mechanism employs the job data to print the obverse side of a sheet and the second printing mechanism employs the job data to print the reverse side, or wherein the first and the second single-sided printing mechanisms are employed for two-color printing, i.e., print job data is used to print the same side of a sheet using different toner colors. For this printer system, since the print jobs it handles vary in size, from one or two pages to several tens of thousands of pages, when a malfunction, such as a paper jam, that inhibits assured printing occurs, it is vitally important that the printer system have an error recovery printing capability. According to a conventional technique, a controller performs constant monitoring during printing to detect the presence/absence of malfunctions and a printing-completed page position. Upon the detection of a malfunction, and after appropriate corrective action has been taken by an operator, the controller transmits to the host computer the printing-completed page position, and the host computer determines the amount of print job data to retransmit to satisfy the requirements of an error recovery printing range, predesignated at the printing start. When a single conventional printing mechanism is employed, image data within a specific constant range need only be stored in a buffer and read from the buffer after corrective action has been taken for a malfunction, and a pointer need only be retracted because, due to the physical structure of the printing mechanism, the error recovery printing range is a constant. Therefore, printing can be automatically resumed, without the retransmission of print job data by the host computer. However, when two independent printing mechanisms are connected and perform printing in tandem, correct recovery printing is disabled by the conventional technique because, after the malfunction has been corrected, the error recovery printing range varies depending on the deflection of paper at a paper buffer provided between the printing mechanisms.

As one reprinting method, a technique is disclosed in JP-A-2002-137458. According to JP-A-2002-137458, before reprinting is started, print image data having a bitmap form, which is stored in a controller, is read and displayed on a display device to permit an operator to select a page for reprinting. However, according to the technique disclosed in this publication, when the required range for the reprinting is as large as it is when two printing mechanisms are coupled, and when various jobs have been received from a plurality of host computers, sometimes an operator can not depend on his or her personal assessment to select the page to be reprinted, and as a result, appropriate reprinting can not be performed.

Disclosed in JP-A-7-61061 is a technique whereby print image data are stored in a single printing apparatus, and since when a malfunction occurs an operator must merely designate a printing start page, the retransmission of print data by a host computer is not required. However, also according to this technique, a printing start position is selected in accordance with an assessment made by the operator. And therefore, when a large error recovery printing range is required, as when two printing mechanisms are coupled, determining the restart positions for complicated print jobs that have been received from a plurality of host computers is difficult.

There is another type of printer system wherein two single-sided printers are interconnected to perform double-sided printing, or are separately operated to perform single-sided printing. To control these printers and to perform double-sided printing, a synchronous printing method is employed for the two printers (for which separate controllers are provided). As a typical synchronous printing system, disclosed in JP-A-7-237336 is a continuous-form, double-sided printer system wherein printers, for which individual controllers are provided, synchronously perform printing by employing a unit for transmitting physical page differences between a host computer and an intermediate, sensor equipped buffer. Since the continuous-form, double-sided printer system includes the sensor equipped intermediate buffer and the individual controllers, the cost is increased because a large number of parts are required, the transmission of data by host computers to the individual controllers is complicated, and the loading of paper is difficult. Therefore, a demand exists for a low cost double-sided printer system for which only a small number of parts are required and for which a simplified paper loading process is provided, i.e., a double-sided printer system that does not include an intermediate buffer mechanism and individual controllers and that does not impose a complicated workload on a host computer.

### SUMMARY OF THE INVENTION

When printers are connected to an open network, various types of printers are connected to a variety of host computers, and accordingly, various types of applications are employed to create print jobs. Therefore, appropriate print job data are not always retransmitted in response to a malfunction report transmitted by the printers. Furthermore, when the error recovery printing range is divided to provide for short jobs that are separately received from a plurality of host computers, some of the host computers may not retransmit job data, so that error recovery printing can not be performed for an appropriate range.

Furthermore, according to the conventional double-sided printing method, after a first printing mechanism has printed the obverse side of a sheet, a paper inversion mechanism inverts the sheet and the second printing mechanism prints the reverse side. Therefore, the operations of the two printing mechanisms must be synchronized. And for synchronous printing, in a state wherein a specific double-sided printing job has been completed and the printing of the next job is pending, the first printing mechanism performs the printing for the obverse side and enters a standby state, while a quantity of reverse side drawing data, equivalent to the length of a paper path extending from the first to the second printing mechanism, is stored in memory. This state is called a print data wait state. At this stage, the following problems have arisen.

1. For the printer system, a sensor for detecting a paper jam is not located between the first and the second printing mechanisms. Therefore, if a paper jam occurs between the printing mechanisms, corrective action can not be taken until the malfunction is detected by an apparatus when the next print data are to be printed. As a result, paper is wasted.

2. Conventionally, when paper is loaded, an operator sequentially initiates the printing of the number of paper sheets that has been requested, and confirms the length of an extended paper path between the printing mechanisms and enters this distance in a controller. Therefore, even when the operator finds an input error later, there is no way the operator can easily reinput the data.

3. When a paper roll supply device is connected, paper must be reloaded in order to change the length of a paper path. Since synchronous printing is employed, the length of the paper path can not be changed immediately after the single-sided print data received from the host computer has been printed by the first printing mechanism, i.e., the entry of a change must be delayed until the paper sheet reaches the second printing mechanism. Therefore, the paper segment extending from the first to the second printing mechanism is wasted.

Because of these problems, the operator must remove and reload paper. These operations must be manually performed, and a large number of steps is required to remove a paper jam. Furthermore, when a paper jam malfunction has occurred, the paper segment extending from one printing mechanism to the other is wasted, and additional paper is wasted during the paper-reloading operation.

To resolve these technical problems, it is one objective of the present invention to provide a printer system wherein a plurality of printing mechanisms synchronously perform printing, and wherein, when a malfunction that inhibits assured printing occurs, error recovery printing and the resumption of printing for a current print job can be performed precisely and automatically, even when full knowledge of the print job is not provided the operator.

It is another objective of the present invention to provide a printer system wherein an operator, by performing a simple input operation, can set to the a synchronous state a plurality of printing mechanisms that are presently printing synchronously, or can advance paper extended an arbitrary distance between the individual printing mechanisms, wherein paper can be bonded at an arbitrary location, so that, when a paper jam between the printing mechanisms or an input error occurs, paper wastage can be avoided, and wherein, when a paper roll supply device is connected, the required number of paper loading steps can be reduced.

Provided for a controller is a memory buffer having a capacity large enough to store page image data for a range exceeding the maximum predicted length of a paper path between a plurality of printing mechanisms.

A unit is further provided for determining a length δ of the paper path between the printing mechanisms, and for transmitting the length δ to the controller. Using this unit, the distance between the printing mechanisms can be designated in advance. The value for this distance may be entered by visually monitoring the deflection of paper that originally was loaded.

Based on the input length δ of the extended paper path between the printing mechanisms, and a length λ of an unfixed printing portion, which is determined by the internal structures of the printing mechanisms, the controller calculates a distance from a printing start point for the first printing mechanism to a fixing point for the last printing mechanism, and monitors the location of a printing-completed page constantly during printing.

When printing is begun, the controller sequentially opens print data and creates print image data. At this time, the print image data used by the individual printing mechanisms are developed, in the memory buffer, as a set of data composed of obverse and reverse page image data.

When a malfunction occurs, based on the printing-completed page location, a range is calculated by adding the distance δ and the length λ, which were previously obtained, and in addition, a calculation is performed to compensate for a difference in lengths that is generated when paper is reloaded. Then, data in the page image buffer are traced back and new printing restart page data are determined.

When the printer system has recovered from the malfunction, the controller receives a print restart request from the operator, restarts the printing beginning with the new printing restart page, and automatically performs printing for an error recovery range.

Even when a malfunction occurs and the printing mechanism outputs a notification that assured printing is inhibited, based on an operator's assessment, the printer system may not perform the error recovery printing.

When a paper jam occurs between the printing mechanisms that are waiting for the print data, or when the operator makes an input error or the physical length of a page is changed because of the loading of a paper roll, provided for the printer system are units for permitting the operator to synchronize the printing mechanisms that are currently performing synchronous printing, to easily advance paper from an arbitrary printing mechanism, and to synchronize the printing mechanisms after paper has been bonded and been adjusted.

### BRIEF DESCRIPTION OF THE DRAWINGS

The present invention may be more readily described with reference to the accompanying drawings:

FIG. 1 is a schematic diagram showing a printer system according to a first embodiment of the invention;

FIG. 2 is a diagram showing a paper inversion mechanism and a paper buffer according to the first embodiment of the invention;

FIG. 3 is a schematic block diagram showing a controller according to the first embodiment;

FIG. 4 is a diagram showing the state wherein printing is interrupted according to the first embodiment;

FIG. 5 is a diagram showing the internal state of a page image buffer according to the first embodiment;

FIG. 6 is a schematic flowchart for the printing processing performed according to the first embodiment;

FIG. 7 is a schematic flowchart for the printing restart pre-processing performed according to the first embodiment;

FIG. 8 is a conceptual diagram showing a method for forwarding a management pointer according to the first embodiment;

FIG. 9 is a conceptual diagram showing the correction of an error recovery printing area according to the first embodiment;

FIG. 10 is a schematic diagram showing a printing path according to the first embodiment;

FIG. 11 is a diagram for explaining a double-sided printer system and a paper feeding path according to a second embodiment of the invention;

FIG. 12 is a diagram for explaining a hardware block according to the second embodiment;

FIG. 13 is a block diagram for explaining a control program according to the second embodiment;

FIG. 14 is a diagram for explaining a paper loading method according to the second embodiment;

FIG. 15 is a diagram for explaining a synchronous printing principle according to the second embodiment;

FIG. 16 is a diagram for explaining a main screen and a physical value adjustment sub-screen according to the second embodiment; and

FIG. 17 is a panel control flowchart according to the second embodiment.

### DETAILED DESCRIPTION OF THE PREFERRED EMBODIMENTS

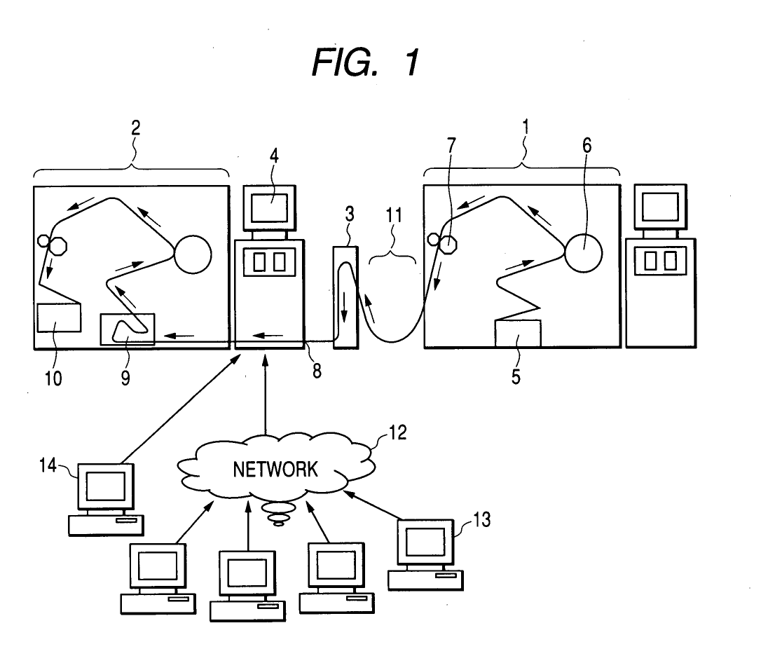

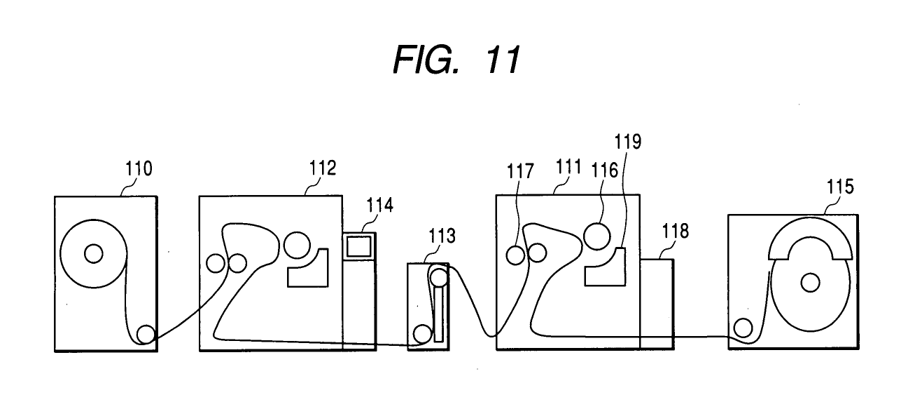

A printer system according to a first embodiment of the invention is shown in FIGS. 1 to 10, while a printer system according to a second embodiment of the invention is shown in FIGS. 11 to 17.

[First Embodiment]

FIG. 1 is a schematic diagram showing a printer system according to the first embodiment of the invention. The printer system includes a first printing mechanism 1, a second printing mechanism 2, a paper inversion mechanism 3, a printer controller 4, and a paper buffer 11.

The first and second printing mechanism 1 and 2 are separately provided, and can also be used as independent printers. As is shown in FIG. 1, a latent image is formed on a printing drum 6 by the optical unit (not shown) of the first printing mechanism 1, and is transferred to a sheet that has been loaded into and fed from a hopper 5 provided for the first printing mechanism 1. The resultant sheet is conveyed along a paper path inside the first printing mechanism 1, and is discharged through a fixing unit 7. The paper buffer 11 and the paper inversion mechanism 3 located between the first and second printing mechanisms 1 and 2 adjust the paper feeding distance. The sheet is then inserted through a paper insertion unit 8 of the second printing mechanism 2 and is pulled by an urging unit 9. Following this, the same components as are provided for the first printing mechanism 1 are employed to convey the sheet and to transfer a latent image to the sheet and fix the image on the sheet, and the resultant sheet is discharged by a paper discharge unit 10. Since the paper inversion mechanism 3 and the paper buffer 11 are provided between the paper discharge unit of the first printing mechanism 1 and the paper insertion unit 8 of the second printing mechanism 2, these printing mechanisms 1 and 2 can be separated by an arbitrary interval. The printer controller 4 monitors the operations of the first and second printing mechanisms 1 and 2, and transmits a control signal and a video signal them while synchronizing their operations and enabling double-sided printing or two-color printing. A network 12, to which a host computer 13 is connected, is used to transmit print jobs to the printer system, while a host computer 14 is directly connected to the printer system directly, and does not communicate across the network 12.

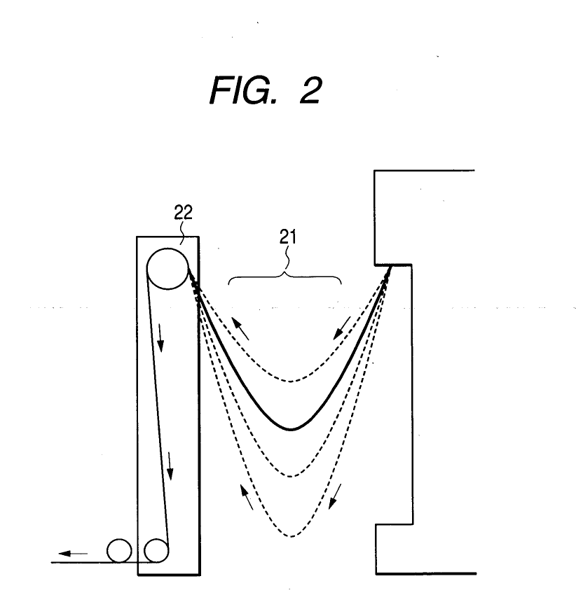

For the thus arranged printer system, as is shown in FIG. 2, the length of the paper path changes, depending on a paper buffer 21 inserted between the printing mechanisms.

Various methods can be used to determine a length δ of the paper path. In this embodiment, when paper is loaded, the first printing mechanism 1 sequentially performs printing to which page numbers are added, and the number of copies printed by the first printing mechanism 1 and the page numbers are visually confirmed as the copies enter the second printing mechanism 2. Through this processing, the length δ of the paper. path between the printing mechanisms 1 and 2 is determined.

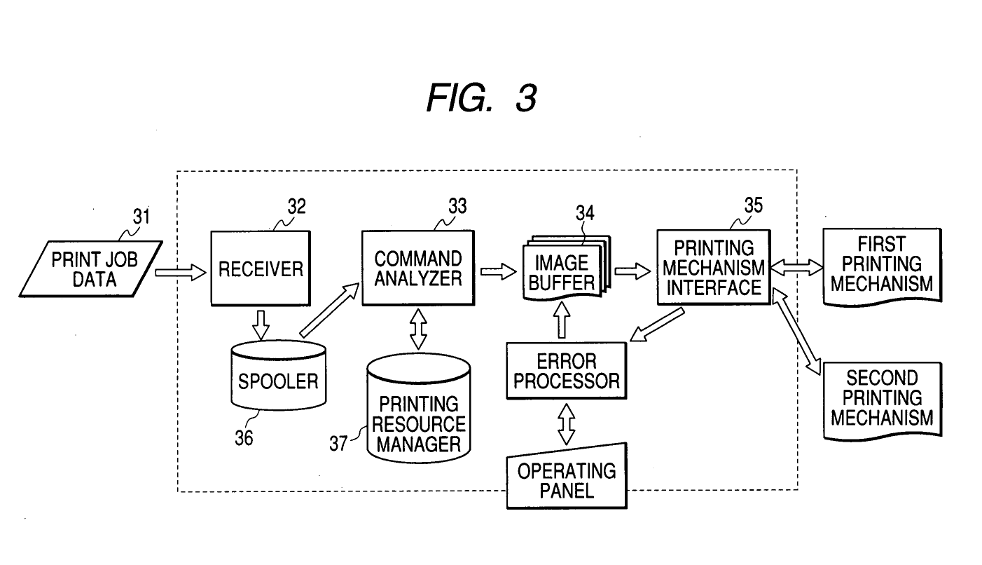

FIG. 3 is a schematic block diagram showing the controller of the printer system according to the embodiment of the invention.

In the printer system, a receiver 32 receives print data 31 from a host computer across a network or through a local interface connection with the host computer. A command analyzer 33 analyzes the print data, and based on the analyzation results, an expansion unit (not shown) expands, as needed, the print data into print image data using a printing resource, such as a font or an overlay, that is stored in a printing resource manager 37. The expansion unit sequentially expands and stores, in a page image buffer 34, paired sets of image data to be printed on one physical sheet, e.g., paired image data for an odd-numbered page to be printed on the obverse side of a sheet and image data for an even-numbered page to be printed on the reverse side. The page image data that is thus stored is read by a printing mechanism interface 35, and is printed in accordance with the operational timings for the individual printing mechanisms.

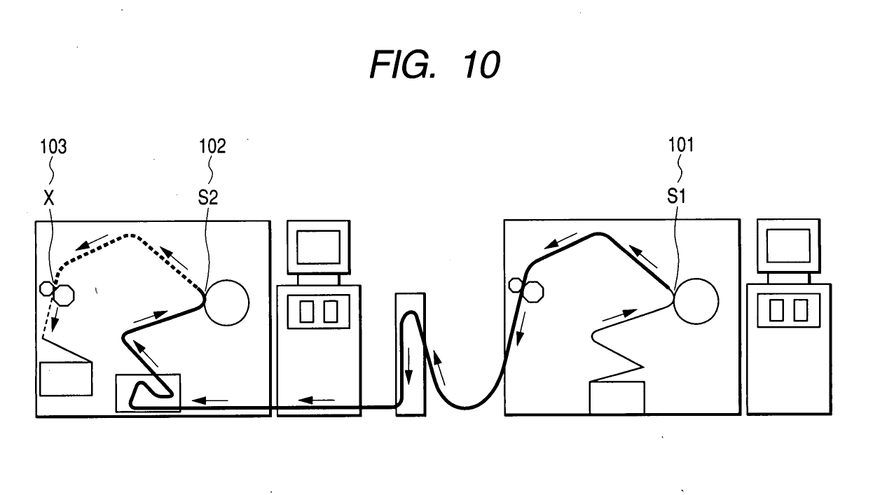

FIG. 10 is a schematic diagram showing a paper path provided in the printer system according to the embodiment of this invention. In FIG. 10, a path indicated by a thick solid line, extending from a printing start point 101 of the first printing mechanism 1 to a printing start point 102 of the second printing mechanism 2, is regarded as a paper path between the printing mechanisms 1 and 2, and the length of the paper path is defined as paper path length δ. Further, the distance indicated by a broken line, from the printing start point 102 of the second printing mechanism 2 to a fixing point 103, where data is fixed to a sheet, is defined as a length λ.

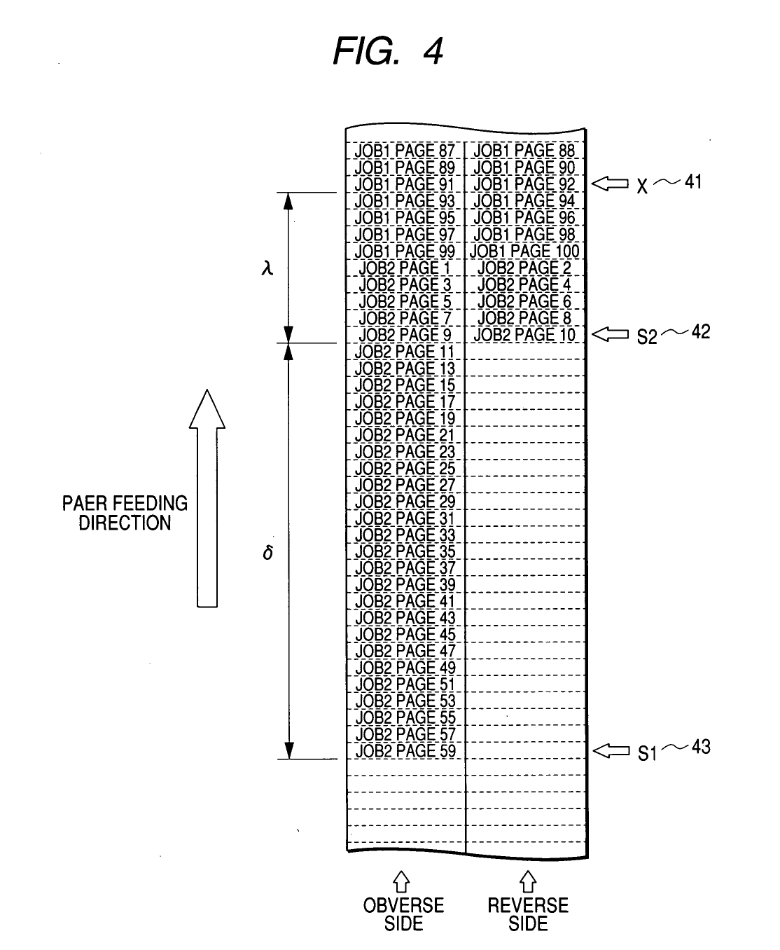

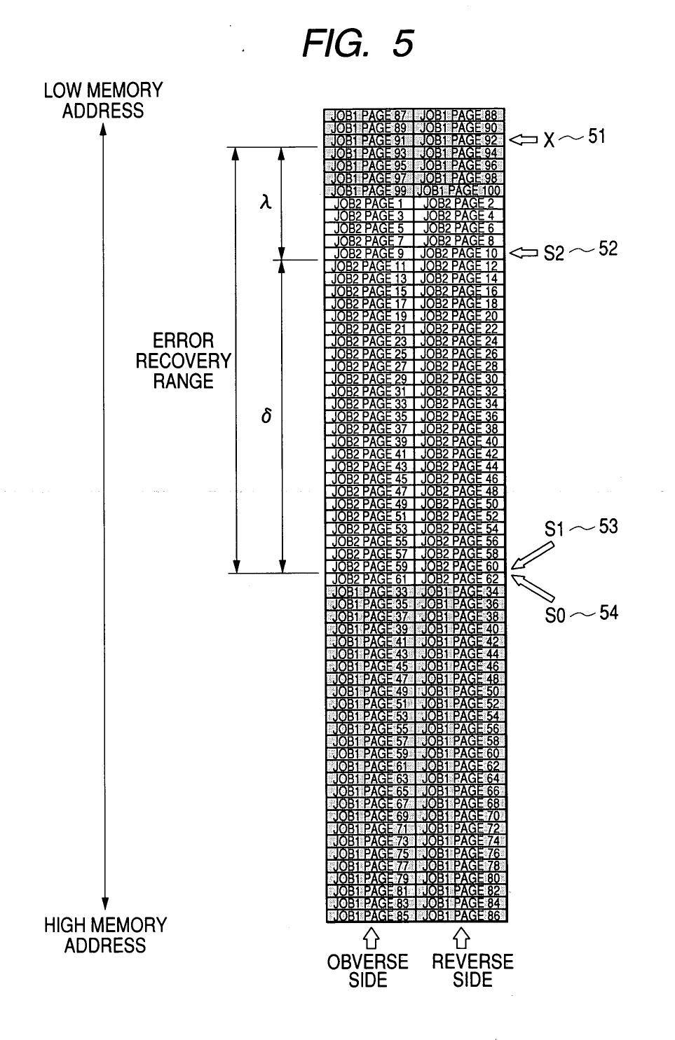

The structure of the page image buffer 34 will now be explained while referring to FIGS. 4 and 5. Assume that the job printing performed by the printer system in this embodiment is interrupted, that the physical printing results printed on a sheet provided by the individual printing mechanisms are shown in FIG. 4, and that the internal state of the page image buffer 34 is as shown in the conceptual diagram in FIG. 5. In FIG. 4, which shows the physical printing results, a printing assurance point 41 indicates a page that has been passed through the fixing point 103 of the second printing mechanism 2. A first printing start point 43 indicates the printing start point of the first printing mechanism 1, and a second printing start point 42 indicates the printing start point of the second printing mechanism 2. Similarly, in FIG. 5, a printing assurance point 51, a second printing start point 52 and a first printing start point 53 are shown. In the page image buffer, a set of image data for the obverse side of a sheet and image data for the reverse side is stored as is shown in FIG. 5, and the range from the first printing start point 53 to immediately before the printing assurance point 51 is stored as an error recovery range. As printing is performed, the individual points are sequentially shifted from a low memory address to a high memory address. When the highest memory address is reached, the expansion start point is shifted to the lowest address, and old, previously written image data are over written, so that a ring buffer, to be used later, is formed. A control program for the expansion unit (not shown) inhibits the passage of the expansion start point 54 to go over the printing assurance point 51 for performing the print image expansion process.

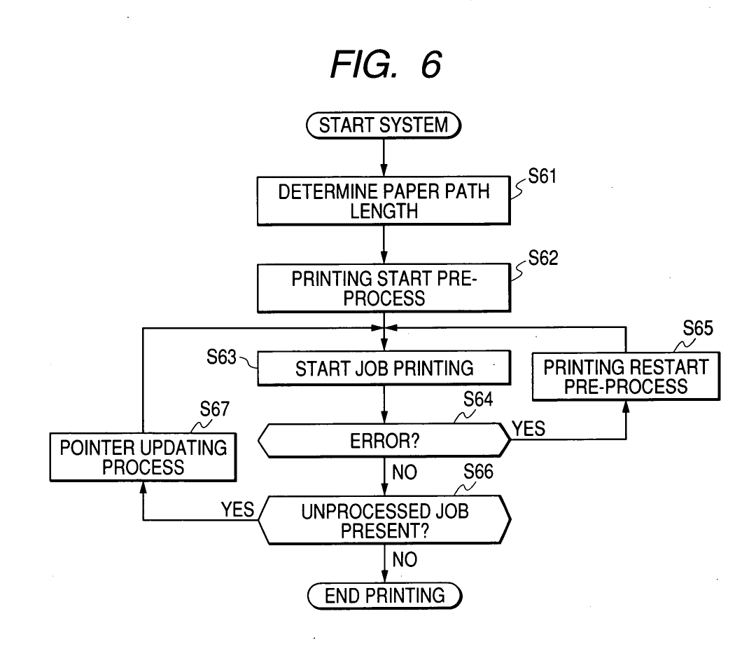

FIG. 6 is a flowchart presenting an overview of the printing processing performed according to the embodiment. First, when the printer system is activated and paper is manually loaded by an operator, the paper path length δ between the printing mechanisms 1 and 2 is determined and entered in the printer system (S61). Thereafter, upon the reception of print data through an interrupt process (not shown), a printing start pre-process (S62) is performed to expand, in the image buffer, job data that is stored in a spooler. Then, a pointer is set for managing the data in the image buffer 34, and the printing of the job is started (S63). Following this, an error monitoring process (S64) and a job completion monitoring process (S66) are performed. When the printing processing is normally terminated and unprocessed job data still remain, the management pointer is advanced (S67), page image data for the next job are expanded, and the printing process is performed. When the job printing is not normally terminated, due to the occurrence of an error, the management pointer is reset, by a printing restart pre-process (S65), and the printing is restarted.

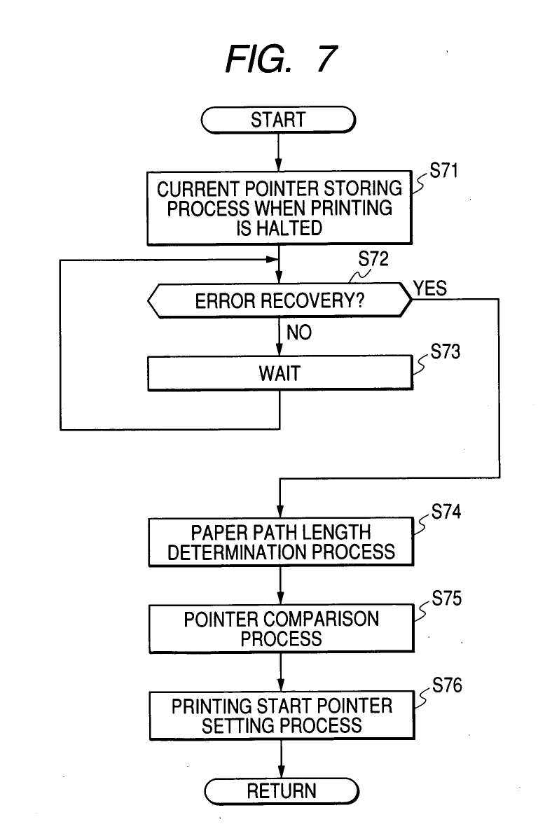

The printing restart pre-process performed upon the occurrence of a malfunction will now be explained while referring to the schematic flowchart in FIG. 7. First, when a malfunction, such as a paper jam, halts the printer system and assured printing is inhibited, the pointer in the current state is stored (S71) and the processing is delayed until the operator eliminates the cause of the malfunction (S72 and S73). In this case, the recovery from the malfunction indicates a manual operation was performed by the operator, e.g., the removal of the paper jam in the printing mechanism. When, as a result of the error recovery process, paper is re-loaded and the paper path length δ between the printing mechanisms 1 and 2 is changed, the operator again determines the length δ of the paper path and reenters it (S74). Thereafter, the new paper path length δ and the location of the pointer when the printing was halted are employed to calculate the position, in the paper buffer, of the page at which to start printing, and the printing start pointer is set (S75 and S76).

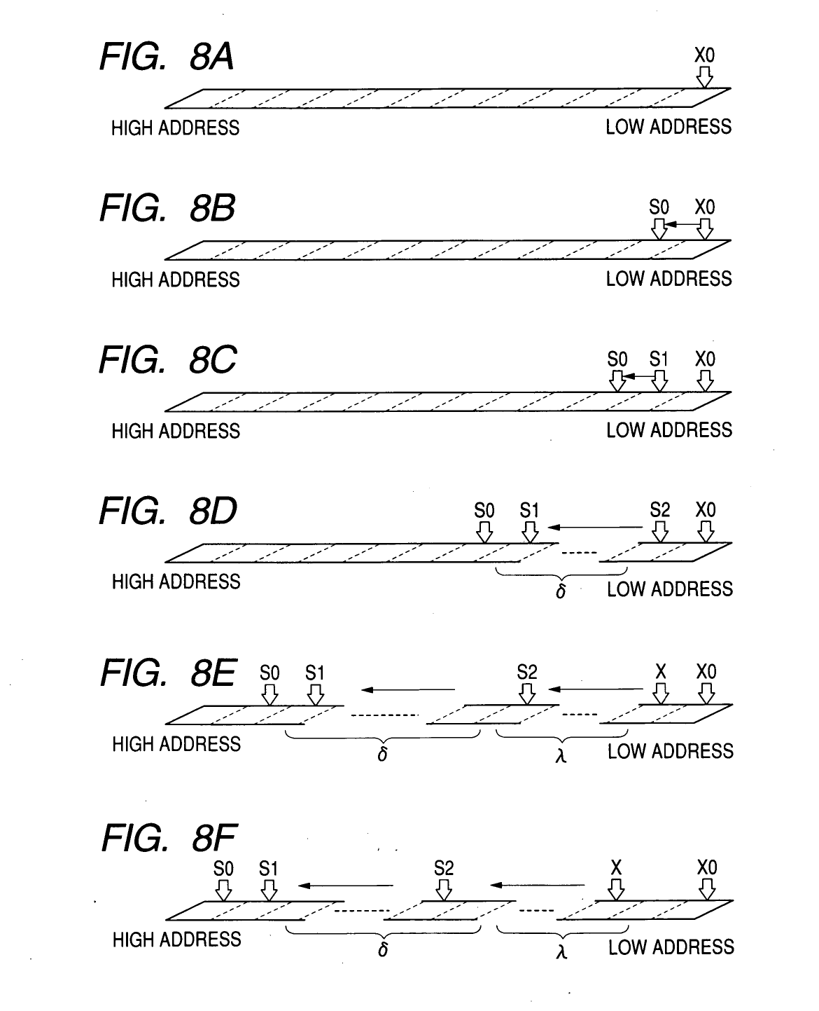

The method for advancing the management pointer that is used upon the execution of printing will now be described while referring to FIG. 8, wherein the concept of the image buffer 34 is shown. As is shown in FIG. 8-1, the location in the image buffer 34 whereat first page image data is expanded is defined as X0. When page image data has been expanded at the point X0, the pointer is shifted, in the direction in which a sheet is forwarded, to the position S0, shown in FIG. 8-2, whereat the next image data is to be expanded. The expanded image data is read from the position X0 and output to the first printing mechanism 1. Then, as is shown in FIG. 8-3, the image expansion position is shifted to position S0, while the pointer points at S1, which is the position of the image data to be output to the first printing mechanism 1. As the printing continues, the pointer at S0 and S1 are moved forward, away from X0. When the distance between S1 and X0 equals the length δ of the paper path between the printing mechanisms 1 and 2, the expanded image data for the reverse side of the sheet is read from the position X0, and is output to the second printing mechanism 2. Thereafter, as is shown in FIG. 8-4, the pointer is advanced from the position X0 to a position S2, which is the printing start point 102 for the second printing mechanism 2. It should be noted that when the pointer is advanced, a constant distance (the paper path length δ) is maintained between the points S1 and S2. When the distance between S2 and X0 is equal to the distance λ from the printing start point 102 of the second printing mechanism 2 to the fixing point 103, as is shown in FIG. 8-5, the pointer is advanced from X0 to X, which becomes the printing assurance point. The length δ+λ, the distance between the points S1 and X, in the image buffer 34 is stored as the range for the performance of recovery printing following the occurrence of a malfunction.

In the example shown in FIG. 8, the image expansion position S0 is one page forward of the position S1. However, when the image expansion speed is considerably higher than the printing speed of the printing mechanism, the pointer can be moved further forward. In such a case, the point S0 may be two or more pages ahead of the point S1.

Since the image buffer 34 has a ring buffer structure, as the pointer continues to be moved forward, it is finally returned, from the position S0, to the position X0. In this embodiment, when the pointer is advanced further, the movement of the position S0 beyond the position X is inhibited in order to perform reprinting following the error recovery process, and the image data in the reprinting range, which is stored in the image buffer 34, is protected.

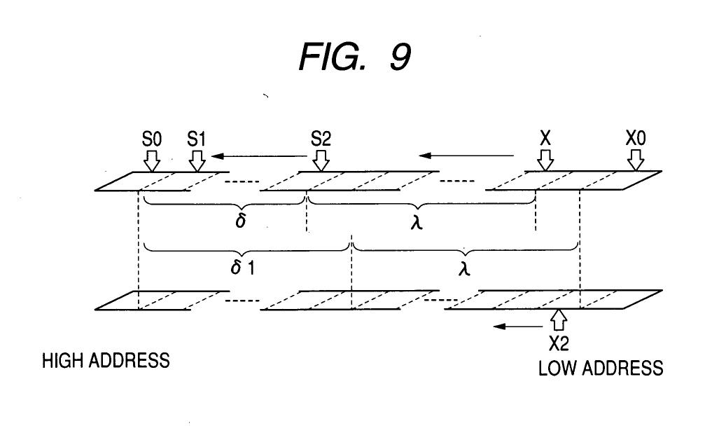

Suppose that printing is being performed while the pointer is being forwarded in the above described manner, and that a malfunction, such as paper jam, occurs for which reprinting is required. Further, assume that the state of the extended sheet at the paper buffer 11 is adjusted during the paper loading operation, and that as a result, the length of the extended paper path between the printing mechanisms is changed from δ to δ1. As is shown in FIG. 9, a location determined during the printing restart pre-process, by tracing back the data a distance δ1+λ from the pointer position S1 where at the printing was halted, is designated the new printing start position X2 for the first printing mechanism 1, and the printing is resumed. Since image data within the range X2 to S0 has already been expanded, the image data that are read from the image buffer 34 during the printing process need not be expanded. Thus, since no expansion processing is required, the error recovery time can be reduced. And as the pointer is advanced from the new printing start point X2, the points S2 and X are set in the same manner as previously described in accordance with the distance forwarded. A pointer management program in the controller defines, in advance, a maximum permissible value δmax as a printing assurance point, while taking the maximum path length into account, so that when the paper path length δ is changed, the error recovery printing range is assured. Therefore, when the pointer at the printing assurance point X is advanced, an appropriate margin should be obtained. In this case, a unit may be provided by which an operator can enter the maximum permissible value δmax for the path length, so that an appropriate change value can be determined in accordance with the installed state of the printer system. Further, image data for a printed page (a page that has passed through the fixing point 103 of the second printing mechanism 2) is deleted from the image buffer 34 when the image data has passed through a range obtained by tracing back a distance δmax+δ from the expansion start point S0. With this arrangement, error recovery printing can be performed that can cope with the paper path length of the maximum permissible value δmax.

In this embodiment, a paper buffer has been provided between the printing mechanisms to compensate for a time lag in the synchronous operation of the mechanisms. However, when the synchronous operation can be satisfactorily performed, the printing mechanisms may be connected together without an intervening buffer being provided.

Furthermore, when a post-printing processor is connected to the printer system of this embodiment, a unit maybe provided by which the operator can enter, as an error recovery printing range, the distance from the fixing point 103 of the second printing mechanism 2 to the discharge port of the post-printing processor. With this arrangement, a quantity of page image data equivalent to the extended length can be stored in the page image buffer 34, and the same processing need only be performed for the error recovery printing.

In addition, the printer system in this embodiment may further include a unit, an operation panel, a user can employ to input an instruction indicating whether error recovery printing is to be performed following the performance, for the printer system, of an error recovery process.

According to the present invention, the printing mechanisms can also be applied for cut-sheet printers.

According to the thus explained method, in a printer system wherein the operations performed by a plurality of independent printing mechanisms are synchronized, a position where at printing should be restarted can be automatically determined when, during printing, a malfunction has occurred for which reprinting is required. Therefore, beginning at the point whereat a print job was interrupted, a reprinting operation can be easily and automatically performed, without the retransmission of data from a host computer, even when full knowledge of the required printing results has not been provided an operator.

[Second Embodiment]

FIG. 11 is a diagram showing the configuration of a printer system and a paper path provided for a printer system according to a second embodiment of the invention. First, a path along which roll paper is conveyed will be explained. Roll paper is fed from a paper roll supply device 115, is passed through, at the bottom of a power operation box 118, and is conveyed to a first printing mechanism 111. In the first printing mechanism 111, based on first-side image data that has been expanded by a controller 114, toner is attached to a photo sensitive drum 116, to form a toner image thereon, by a developing unit 119, and the toner image is transferred to the supplied paper. Thereafter, the toner image is fixed to the paper by a fixing unit 117. Then, in the first printing mechanism 111, a paper inversion mechanism 113 changes the paper feeding direction, or inverts the image-bearing paper, and the paper is passed through the bottom of the controller 114 and transmitted to a second printing mechanism 112. The second printing mechanism 112, as does the first printing mechanism 111, prints drawing data, but for the second side, and the resultant printed paper is wound around the paper roll winding device 110. That is, since the paper inversion mechanism 113 changes the side of the paper that is printed, double-sided printing is enabled.

Further, instead of the paper being inverted by the paper inversion mechanism 113, toners used by the printing mechanisms 111 and 112 may be exchanged for color toners other than black or magnetic toners. Spot-color or magnetic toner printing can then be performed.

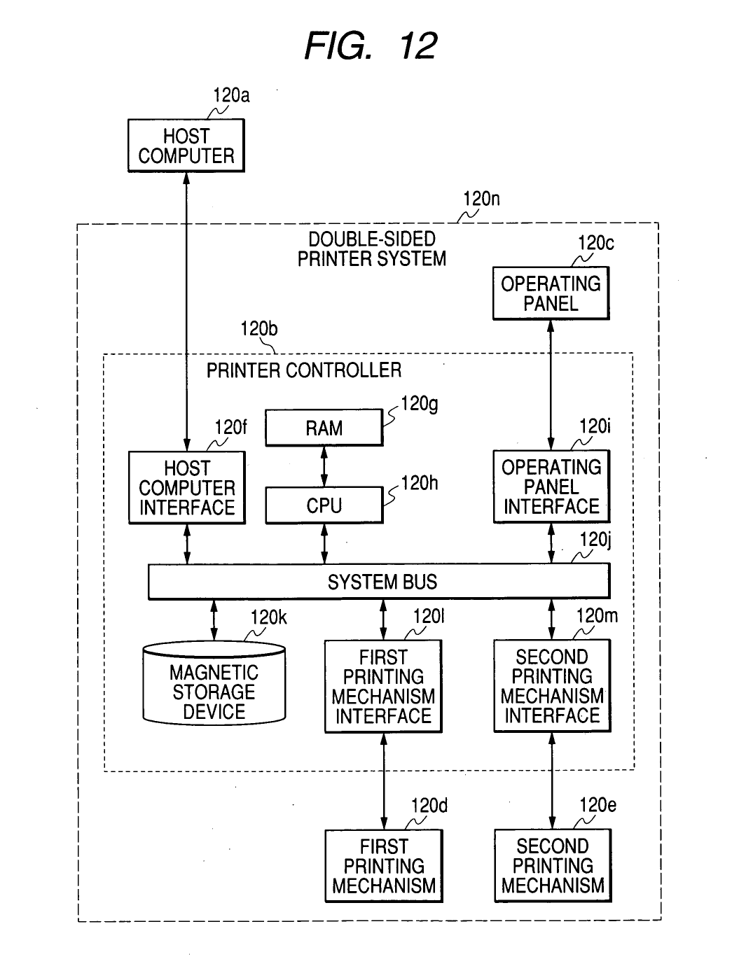

FIG. 12 is a hardware block diagram for explaining the printer system according to the second embodiment of the invention. The essential portion of the printer system includes a printer controller 120b, an operating panel 120c, a first printing mechanism 120d and a second printing mechanism 120e. The printer controller 120b includes a host interface 120f, a CPU 120h, a RAM 120g, an operating panel interface 120i, a magnetic storage device 120k, a first printing mechanism interface 120l, a second printing mechanism interface 120m and a system bus 120j for interconnecting these sections. The printing mechanisms 120d and 120e are respectively connected to the printing mechanism interfaces 120l and 120m, and the host computer 120a is connected to the host interface 120f. When the printer system is powered on, a control program in the magnetic storage device 120k is stored in the system area of the RAM 120g and activated. In accordance with the control program stored in the system area of the RAM 120g, the CPU 120h is activated and provides control for the entire printer system.

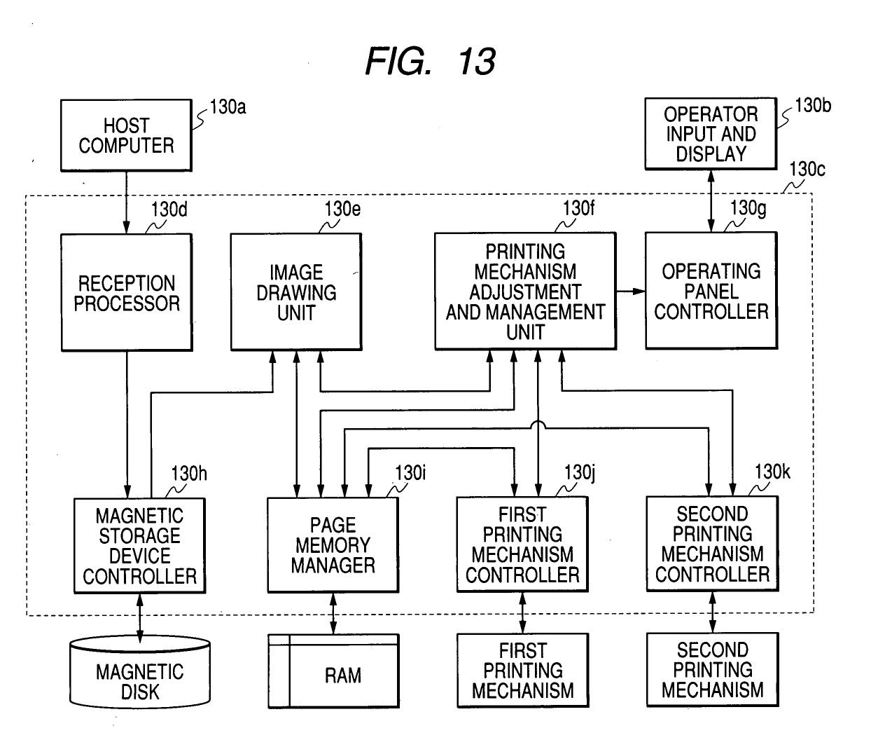

FIG. 13 is a block diagram for explaining the control program employed by the printer controller 120b. A control program group 130c includes a reception processor 130d, an image drawing unit 130e, a printing mechanism adjustment/management unit 130f, an operating panel controller 130g, a magnetic storage device controller 130h, a page memory manager 130i, a first printing mechanism controller 130j and a second printing mechanism controller 130k.

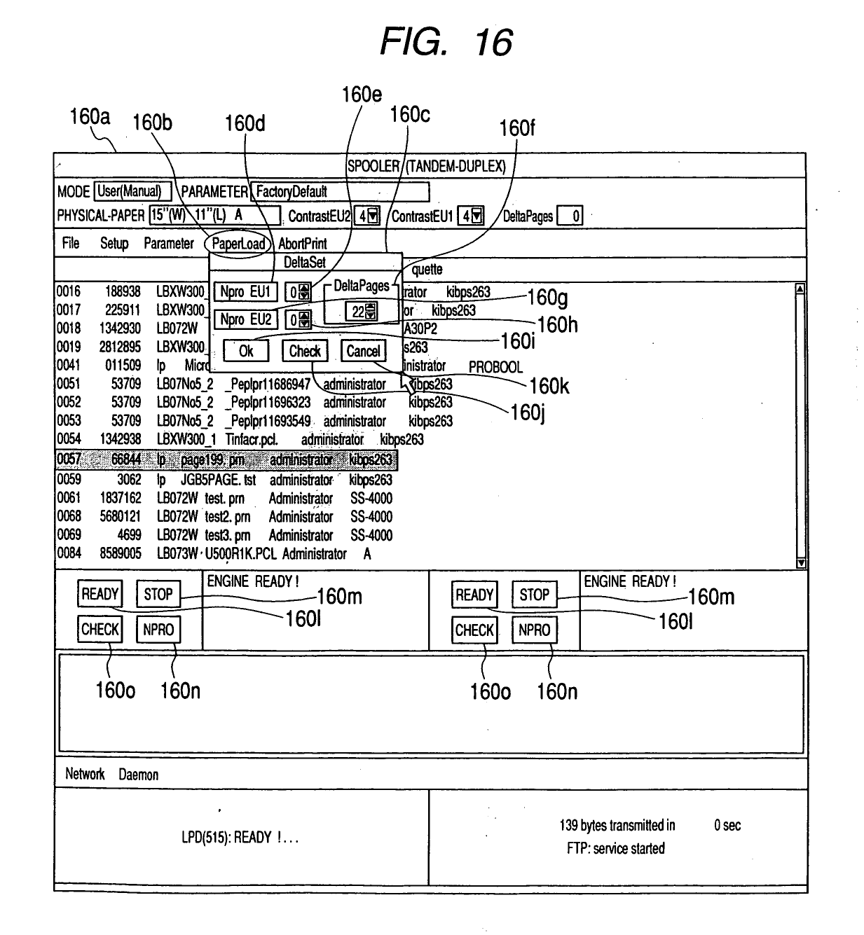

Document data received from a host computer 130a are processed by the reception processor 130d, and are transmitted to the magnetic storage device controller 130h, which stores the data on a magnetic disk. The image drawing unit 130e expands, into drawing data, the document data stored on the magnetic disk, and transmits the expanded drawing data to the page memory manager 130i. The page memory manager 130i stores in a memory, and manages, the drawing data for the document data. At this time, when an instruction is issued by an operator entry and display block 130b using the operating panel 120c, i.e., when an operator manipulates a READY key 160l (see FIG. 16) on the operating panel 120c, the operating panel controller 130g processes the key depression and designates a printing start point, and the printing mechanism adjustment and the management unit 130f activate the printing mechanism controllers 130j and 130k by using, as an argument, a drawing data address in the memory. Based on the drawing data address designated by the first printing mechanism adjustment and management unit 130f, the first printing mechanism controller 130j extracts drawing data from the memory and permits the first printing mechanism to transfer the drawing data to paper. Similarly, based on the drawing data address designated by the printing mechanism adjustment and management unit 130f, the second printing mechanism controller 130k extracts drawing data from the memory and permits the second printing mechanism to transfer the data to paper. When a malfunction occurs in either of the printing mechanisms, the printing mechanism adjustment and management unit 130f and the operating panel controller 130g display a malfunction notification on the operating panel 120c.

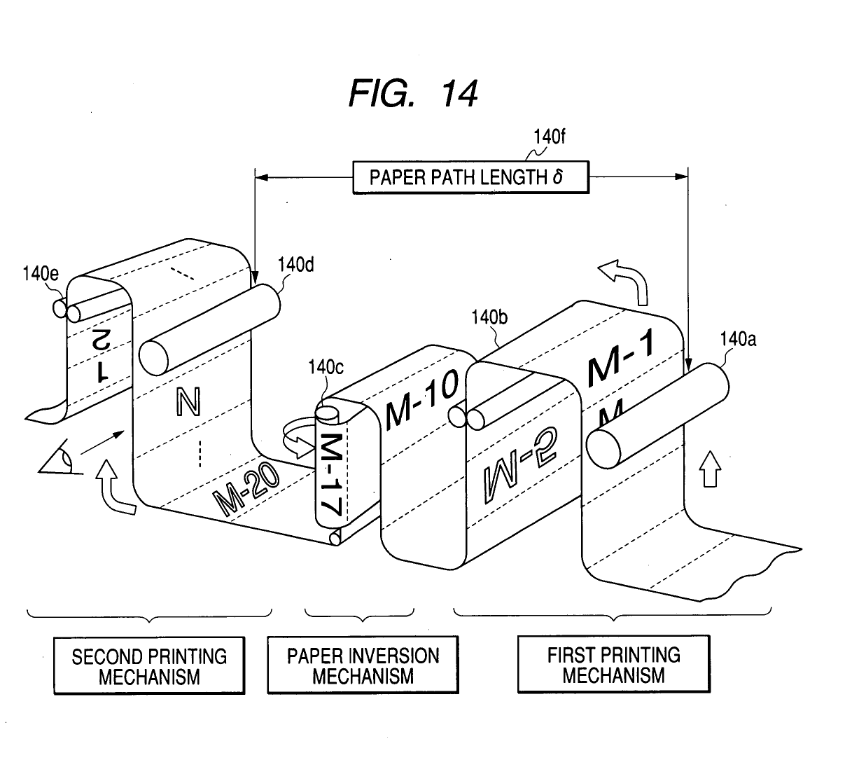

FIG. 14 is a diagram for explaining a paper loading function. For this explanation, sequential numbers are employed for a print sample. The paper loading function is a function whereby, based on a physical page size previously entered an operator, support is provided for a paper loading operation performed by the operator. The paper loading function also serves as a unit whereby the printer controller 120b obtains the paper path length δ that is used for synchronous printing performed by the first and the second printing mechanisms. First, the operator selects the paper loading function on the operating panel 120c and instructs the printing of M physical pages. Then, the printer controller 120b employs a first printing mechanism photosensitive drum 140a to print sequential numbers (1, 2, . . . , N, . . . , M-1 and M) beginning with 1, and feeds paper a distance equivalent to the physical page size. Thereafter, the operator loads paper into the second printing mechanism using a paper inversion mechanism 140b, and as necessary, loads paper sequentially until a post-processor is reached. At this time, when sufficient paper has been loaded and a paper inversion mechanism 140c can invert the paper, double-sided printing is available. When the paper is loaded so as not to be inverted, spot-color printing, which is double printing on only one side of paper, or magnetic toner printing is available. In this embodiment, an explanation will be given for the processing performed when paper is inverted. The same processing, however, can be performed when the paper is not inverted. After the paper has been loaded, the operator visually confirms the sequential number N printed on the obverse side of the paper, which is located immediately before the second printing mechanism photosensitive drum 140d, and uses the operating panel 120c to enter this sequential number N. The printer system stores the value M−N+1 as the length (δ=M−N+1) 140f of the paper path extending from the first to the second printing mechanisms. Since because of the system structure the sequential number N+1 can not be visually confirmed, the operator enters the sequential number N that can be visually identified, and a difference of 1 is added to this value. As a result, the paper path length δ (140f) is visually obtained and confirmed, and is entered by the operator. For synchronous printing, the operations performed by the first and second printing mechanisms are synchronized, so that the paper path length δ (140f) can be maintained. The synchronous printing operation is a necessary control operation employed in order to provide a printer system wherein individual, single-sided printing mechanisms are sequentially connected.

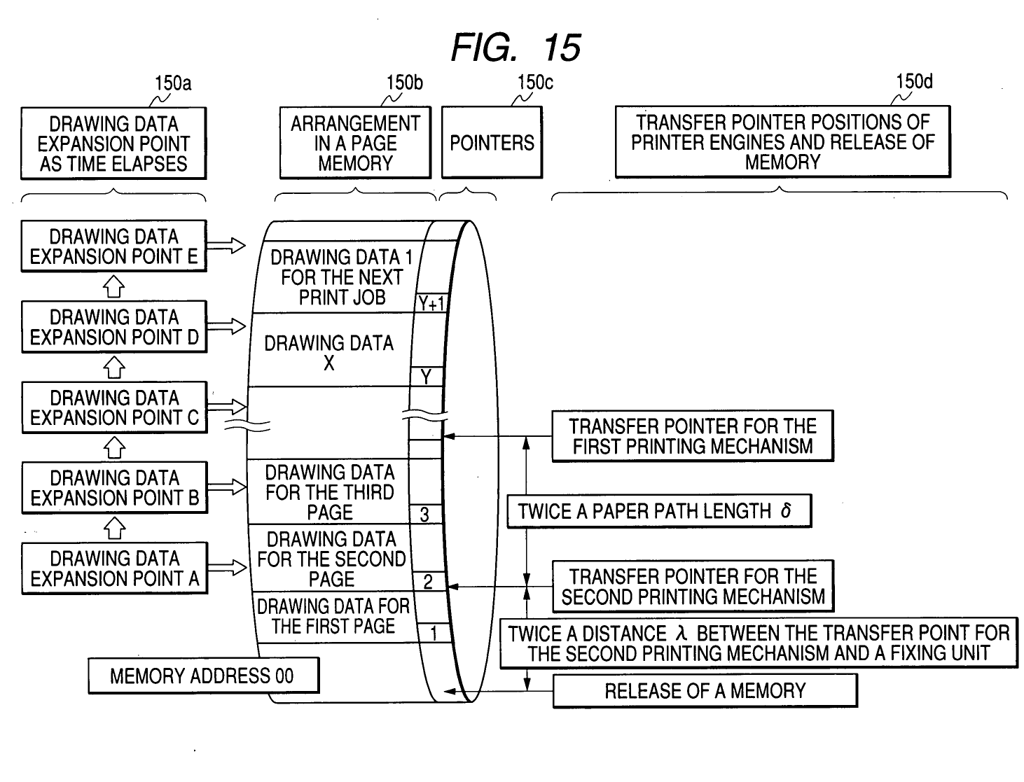

FIG. 15 is a diagram showing the correlation of an arrangement 150b, in a page memory following the expansion of drawing data stored in the RAM 120g, and pointers 150c and a section 150d that indicate both the transfer pointer positions of the individual printing mechanisms and the release of memory. While referring to FIG. 15, an explanation will now be given for the operations performed by the image drawing unit 130e that employs the page memory 150b, the page memory manager 130i, the printing mechanism adjustment and management unit 130f and the printing mechanism controllers 130j and 130k, and the operations performed for synchronous printing and memory release.

Before transferring image data to the printing mechanisms, the image drawing unit 130e expands, in the page memory 150b, document data received from the host computer, and obtains and stores image drawing data. The memory address whereat the next drawing data are stored is called a drawing data expansion point, and in FIG. 5 are shown a shift 150a in this drawing data expansion point that occurs as time elapses, the arrangement 150b in the page memory, the pointers 150c and the section 150d that indicates both the transfer pointer positions of the individual printing mechanisms, and the release of the memory. In this case, the image drawing unit 130e stores in the page memory 150b image drawing data for X pages of document data. At this time, the drawing data expansion point 150a is changed from A to E. The drawing data expansion point A indicates the time whereat the image drawing unit 130e started the expansion of the first document data received from the host computer, and completed the expansion of the data for the first physical page. The page memory manager 130i sets the pointer value 150c (a sequential number Y beginning with 1 and a flag (0, 1) representing double-sided printing) at the head of each drawing data address. After the pointer has been set, the page memory manager 130i notifies the printing mechanism adjustment and management unit 130f of the completion of the pointer setup. The printing mechanism adjustment and management unit 130f examines each pointer value (the sequential number and the flag) 150c, and activates the first printing mechanism controller 130j by using the memory address as an argument. Then, the first printing mechanism controller 130j extracts the drawing data from the page memory 150b, and permits the first printing mechanism to print the drawing data. Further, the printing mechanism adjustment and management unit 130f activates also the second printing mechanism controller 130k without using an argument. It should be noted that the second printing mechanism controller 130k is set in advance, so that, when the controller 130k is activated without an argument, the controller 130k outputs one blank page at first. Therefore, in this case, the second printing mechanism controller 130k performs blank printing (Npro). Sequentially, the printing mechanism adjustment and management unit 130f is shifted to and maintained in the standby state until the printer is updated. Furthermore, at this time, the printing mechanism controllers 130j and 130k monitor the presence/absence of an error in the respective printing mechanisms. With this configuration, an intermediate buffer mechanism having a sensor need not be located between the first and second printing mechanisms.

The drawing data expansion point B represents the time whereat the image drawing unit 130e continues the image drawing data processing, and the pointer value 150c does not yet reach the twice of the value δ of the paper path length. At the drawing data expansion point B, the printing mechanism adjustment and management unit 130f examines the flag. When the flag represents the double-sided printing (flag=1), the first printing mechanism controller 130j processes the memory address pointed by the odd-numbered pointer, while the second printing mechanism controller 130k continues blank printing. The drawing data expansion point C is the time whereat the pointer value 150c exceeds the twice of the value δ of the paper path length, and the image drawing data processing is still continued. At this time, the printing mechanism adjustment and management unit 130f examines the flag. The first printing mechanism controller 130j continuous to process the memory address pointed by the odd-numbered pointer, while the second printing mechanism controller 130k starts to process the memory address pointed by the even-numbered pointer. The drawing data expansion point D is the time where at the printing is terminated while the number X of printed pages does not exceed twice the value δ of the paper path length, i.e., the state wherein the reception of print data from the host computer is awaited, which occurs when the number of pages for a specific job is small. This state corresponds to a condition wherein the reverse side of paper remains blank throughout the processing performed by the second printer. The drawing data expansion point E indicates the state wherein print data for the next print job is to be processed. The pointer values must be sequential in order to fit the positions of the first and the second faces of paper (obverse and reverse sides) and to release the memory. When the number of pages for the preceding print job ends with an odd number, the image drawing unit 130e inserts blank drawing data, so that an even-numbered pointer comes last. As a result, the first page of the next print job can always be printed on the obverse side of paper.

When the number X of pages for drawing data is greater than a value obtained by adding twice of the paper path length δ and the twice of the distance λ from the photo sensitive drum of the second printing mechanism to the fixing unit, for the error recovery process, the printing mechanism adjustment and management unit 130f notifies the page memory manager 130i of the pointer whereat the printing is assured by the second printing mechanism. Based on this pointer, the page memory manager 130i releases the page memory. And as a result, the ring memory management shown in FIG. 5 is performed.

When the print position, fine adjustment FF (Form Feed) key (not shown) for each printing mechanism is depressed in the print data waiting state, a positioning shift occurs between the obverse and reverse sides. And when the individual printing mechanism controllers 130j and 130k are activated for each page, the controllers 130j and 130k constantly detect the positioning shift as an engine malfunction.

FIG. 16 is a diagram for explaining a main screen 160a and a paper path length adjustment sub-screen 160c. The data entry method used by an operator and the synchronous/asynchronous shifting operation will now be described by using the main screen 160a, a paper load category 160b, selected on the main screen 160a, and the paper path length adjustment sub-screen 160c, selected from the entries for the paper load category 160b.

When the READY key 160l is selected on the main screen 160a, the printing of received print data is initiated. And when a STOP key 160m is selected, the operation of the currently operating printing mechanism is halted. A CHECK key 160o is used to perform a resetting process when a malfunction has occurred, specifically, the first and the second printing mechanisms are reset. During the asynchronous printing, the STOP keys 160m, NPRO keys 160n and the CHECK keys 160o, which are located both at the right and left lower portions on the main screen 160a, can respectively be used to control the first and the second printing mechanisms. During the synchronous printing, since the first and the second printing mechanisms are regarded as an integral unit, the two mechanisms perform the same operation upon the depression of the STOP key 160m, the NPRO key 160n and the CHECK key 160o, on either side. When the NPRO key 160n is selected during the synchronous printing, the first printing mechanism performs blank printing for a number of pages equivalent to the value obtained by adding the paper path length δ to the distance λ from the photo sensitive drum to the fixing unit. Synchronously, the second printing mechanism prints an amount of data for the reverse paper side that is the equivalent of the paper path length δ, and then produces the number of blank pages that is the equivalent of the distance from the photo sensitive drum to the fixing unit.

According to the present invention, in order to synchronize the printing operations performed by the two printing mechanisms, when the STOP key 160m is selected during synchronous printing, the paper load category 160b (PaperLoad in FIG. 16) on the task bar of the main screen 160a can be selected. Specifically, when the paper load category 160b is selected, a pull down menu (not shown) is displayed. Then, when the paper path length adjustment sub-screen 160c (DeltaSet in FIG. 16) is selected, the operation is shifted to a synchronous printing, and the paper path length adjustment sub-screen 160c (DeltaSet in FIG. 16) is displayed. The paper path length adjustment sub-screen 160c includes a paper path length display/input area 160f (DeltaPages in FIG. 16), used for the direct entry of the paper path length δ, or to display the current paper path length δ, a blank printing page count input area 160e for the first printing mechanism, a blank printing start/stop key 160d (Npro EU1/Stop EU1 in FIG. 16) for the first printing mechanism, a blank printing page count input area 160h for the second printing mechanism, and a blank printing start/stop key 160g (Npro EU2/Stop EU2 in FIG. 16) for the second printing mechanism. When the individual printing mechanisms are in the Npro operating state, Stop EU1 (the first printing mechanism) and Stop EU2 (the second printing mechanism) are displayed by selecting the blank printing start/stop keys 160d and 160g. When the printing mechanisms are in the Stop state, Npro EU1 (the first printing mechanism) and Npro EU2 (the second printing mechanism) are displayed. The paper path length adjustment sub-screen 160c also includes an OK key 160i, used to instruct a counter to hold the paper path length δ, a Cancel key 160k, used to cancel the holding instruction, and a Check key 160j, used to instruct the resetting of a printing mechanism malfunction during the blank printing operation.

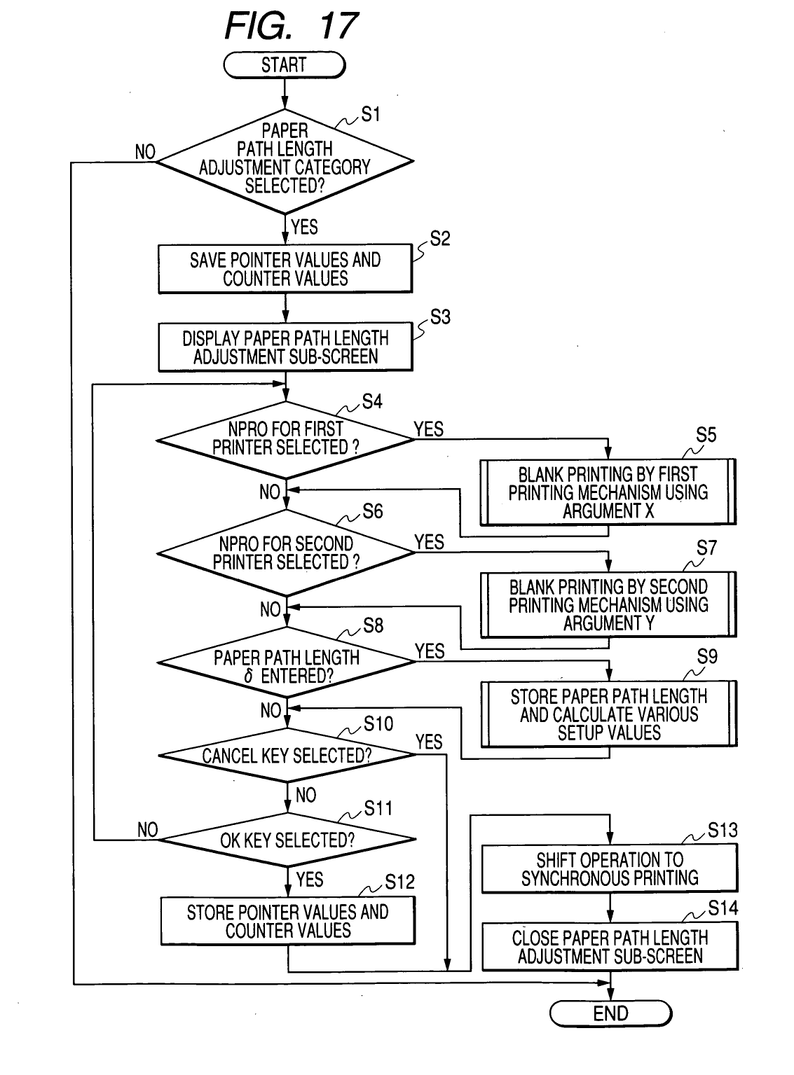

FIG. 17 is a flowchart for the processing performed by the operating panel controller 130g to control the paper path length adjustment sub-screen 160c. The operating method will now be described while taking into account an operation performed by an operator when removing a paper jam that has occurred in the print data waiting state. The sub-screen control program is installed in the operating panel controller 130g, and in order to increase the reliability of the processing performed by the printer controller 120b, a condition is provided that ensures only the STOP state will become active. Under this condition, the operator can select the paper load category 160b on the task bar. The paper load category 160b includes a paper path length adjustment sub-screen selection category, and when the operator selects the paper path length adjustment sub-screen 160c, the routine for shifting the operation to a synchronous printing is enabled.

When a paper jam has occurred during the wait for print data, or when the operator examines the deflection of paper extended between the printing mechanisms and finds a paper path length input error, or when the physical length of a page must be changed at the end of single-sided printing because a paper roll has been employed, first, the operator selects the paper path length adjustment sub-screen selection category (S1). When this operation is selected, the printer system stores the individual pointer values used to perform reprinting after the error is corrected (S2), and sequentially displays the paper path length adjustment sub-screen 160c (S3). The operator then removes jammed, torn paper, enters the actual number of pages removed to the blank printing page count input area 160e for the first printing mechanism, and selects the blank printing start/stop key 160d for the first printing mechanism (S4). Then, blank printing is performed for the number of pages entered in the area 160e (S5). At this time, the operator re-shapes the torn paper by using tape to bond it, and thereafter confirms the paper deflection. When the deflection of paper is excessive, the operator enters an appropriate value in the blank printing page count input area 160h for the second printing mechanism, and selects the blank printing start/stop key 160g for the second printing mechanism (S6). In this manner, blank printing is adjusted using an argumenty (S7). When a paper roll is employed, or when a simple input error has occurred, the value δ of the paper path length is entered directly in the paper path length display/input area 160f (S8). Then, the values of the counters and the pointers are obtained and stored in the memory area (S9). Even when an incorrect paper path length δ has been entered, the length can be re-entered, or the Cancel key 160k may be selected to return to the initial value (S10) When the paper deflection value and the paper path length δ are correct, the Ok key 160i is selected (S11) Then, the initial counter values are abandoned and new pointer and counter values are stored (S12). Thereafter, the operation is shifted to synchronous printing (S13). Then, the processing for the paper path length adjustment sub-screen 160c is terminated, and the display is returned to the main screen 160a (S14).

1. A printer system comprising:
a plurality of printing mechanisms;
a paper inversion mechanism that inverts a paper between the printing mechanisms;
a paper buffer that adjusts a time lag in a synchronous operation performed by the printing mechanism; and
a controller that receives print data from a host computer, and synchronously operates the printing mechanisms to perform double-strike printing or double-sided printing,
wherein the controller includes:
a unit that measures a length of a paper path extended between the printing mechanisms in accordance with an installation state of the printing mechanisms, and enters a setup value to perform error recovery printing;
an image buffer that stores an amount of data equivalent to a distance from an image transfer point of a first printing mechanism to a fixing point of a last printing mechanism;
a pointer function that indicates a location of image data and a location of data in the image buffer, the image data being actually transferred during printing; and
a function that employs the pointer function to calculate a range for error recovery printing and performs the error recovery printing, when a malfunction, such as a paper jam, that requires the error recovery printing has occurred and when a paper is re-loaded.

2. The printer system according to claim 1,
wherein the image buffer has a ring structure according to which, during printing, print image data is stored in the image buffer, and when memory is full, data at a head of a memory address is overwritten and data storage is continued.

3. The printer system according to claim 1, further comprising:
a function that manages a pointer in the image buffer, so that a maximum value for the length of the paper path extended between the printing mechanisms is obtained in advance as a margin, the length of the paper path being changed through a paper re-loading operation after removal of an error.

4. The printer system according to claim 1, further comprising:
a unit that enters a distance from the fixing point of the last printing mechanism to a discharge port of a printing post-processor, as the range for the error recovery printing,
wherein the error recovery printing is performed at a distance equivalent to a length that has been extended.

5. The printer system according to claim 1,
wherein execution of the error recovery printing is selectable, after an error that occurred during printing is removed.

6. The printer system according to claim 1,
wherein a time for deleting, from the image buffer, image data for pages that have been printed is defined as a time when it has passed a point obtained by tracing back from an image expansion start point a distance equivalent to a total of a maximum permissible paper path length and an unfixing range that is determined in accordance with an internal structure of each of the printing mechanisms.

7. The printer system according to claim 1, further comprising:
a unit that changes the printing mechanisms between an a synchronous state and a synchronous state based on an operator input instruction, the printing mechanisms being performing synchronous printing.

8. The printer system according to claim 1, further comprising:
a unit that sets the length of the paper path extending between the printing mechanisms.

9. The printer system according to claim 1, further comprising:
a unit that enables blank printing for an arbitrary number of pages by employing an operator panel sub-screen provided in an a synchronous state.
